(19) United States
(12) Patent Application Publication
(10) Pub. No.: US 2015/0034098 A1
(43) Pub. Date: Feb. 5, 2015

(54) AIR FILTRATION MASK WITH OPENING FRONT COVER

(71) Applicant: Aqua Turf International, Inc., Tequesta, FL (US)

(72) Inventor: James Burnett Schumacher, Tequesta, FL (US)

(21) Appl. No.: 14/329,200

(22) Filed: Jul. 11, 2014

Related U.S. Application Data
(60) Provisional application No. 61/845,084, filed on Jul. 11, 2013.

(51) Int. Cl. A62B 23/02; A41G 7/00; A41D 13/11

(52) U.S. Cl. CPC A62B 23/025; A41D 13/11; A41G 7/00
USPC 128/863

(57) ABSTRACT

Disclosed is an air filtration mask formed from individual connectable components namely a base member, a filter holder member, a filter member, and an optional decorative mask cover member. The base member employs studs which allow the filter holding member to securely attach to the base member by means of holes in latches located around the rim of the filter holder member. A replaceable filter member attaches to the filter holder member snapping into the studs located on the inside of the filter holder. A fashion mask cover member can be attached to the front of the filter holder to enhance the appearance. A fashion scarf or bandana can be further attached to the base of the mask so that the mask assembly can stay completely hidden while worn.

### CROSS-REFERENCE TO RELATED APPLICATIONS

In accordance with 37 C.F.R. §1.76, a claim of priority is included in an Application Data Sheet filed concurrently herewith. Accordingly, the present invention claims priority to U.S. Provisional Patent Application No. 61/845,084, entitled “AIR FILTRATION MASK WITH OPENING FRONT COVER”, filed Jul. 11, 2013. The contents of the above referenced application are incorporated herein by reference in its entirety.

### FIELD OF THE INVENTION

This invention is related to the field of air filtration face masks and respirators used to protect a wearer from pollutants and pathogens in the air.

### BACKGROUND OF THE INVENTION

Commuters in urban areas often wear masks during the time that they are in close proximity to others. People with the flu can spread it to others up to about 6 feet away. According to the USA Center for Disease Control (CDC), approximately 5-20% of U.S. residents are infected with the seasonal flu each year. Furthermore, according to the World Health Organization (WHO), annual epidemics are thought to result in between three and five million cases of severe illness, and between 250,000 and 500,000 deaths every year around the world. Most deaths currently associated with influenza in industrialized countries occur among elderly persons age 65 or older. This data fails to reflect the health risks associated with sever pollution which exists in many other urban areas around the world where the use of air filtration masks can make a difference.

A problem with procedural/surgical masks and respirators that are currently on the market is that they are either incapable of, or it is very difficult for them to provide a tight fit and seal to the face. The critical seal is mentioned as extremely important by all manufacturers to insure the filtration of the air. Gaps between the fabric or filter and the face allowing germs and/or pollution to bypass the filter. The gaps are a result of the type of material that is used and the lack of conformability of the material used. A tight seal is critical to insuring the proper operation of the mask and filter and the safety of the wearer. A wearer going through the trouble of wearing a mask will want to be sure that that it works properly.

In current masks and respirator, the filter or fabric itself is used to create the seal. The rigid fabric of a respirator can be uncomfortable. Also, masks are difficult to take on and off due to the tight elastic straps that must be pulled over the top of a wearer's head. This difficulty in getting the mask on and off is another reason more people do not wear air filtration masks. Access to the mouth and nose cannot be made without taking the mask completely off. The masks must be removed completely to access the nose and mouth as needed, such as for example for drinking, eating, communicating, blowing one's nose, and other needs of the wearer. If the wearer had managed to create a tight seal before it was removed, the seal becomes lost, and securing a proper seal can then be difficult and may take time that the wearer does not have.

Prior art air filtration masks include U.S. Pat. Nos. 1,523,884; 1,987,922; 2,012,505; 2,029,947; 2,447,450; 2,565,124; 3,170,461; 3,603,315; 3,613,678; 3,664,335; 3,884,227; 3,971,369; 3,971,373; 3,985,132; 4,067,876; 4,248,220; 4,300,549; 4,417,575; 4,419,993; 4,419,994; 4,454,881; 4,600,002; 4,688,566; 4,807,619; 4,827,924; 4,850,347; 5,143,061; 5,237,986; 5,322,061; 5,419,318; 5,679,690; 5,706,803; 5,724,677; 5,735,270; 5,694,925; 5,673,690; 6,123,077; 6,148,817; 6,484,722; 6,536,434; 6,568,392; 6,715,489; 6,722,366; 6,886,563; 7,036,507; 7,069,930; 7,131,442; 7,171,967; 7,185,653; 7,210,482; and 8,375,950. These masks provide varying means of preventing pollution and contagions from being inhaled by a wearer, however the masks do not have a method or apparatus that allows the wearer to easily remove and store the filter nearby their face or somewhere on their body so that it is easy and quick to retrieve when they need to put it on, nor do they include a method or apparatus that allows a user access to the nose and mouth area without losing the tight seal critical to the filtration process. Additionally, few if any masks offer any form of fashionable cover or other means of making the masks more attractive and desirable to wear. This lack of fashion is another key reason why more people don't wear masks.

### SUMMARY OF THE INVENTION

Disclosed is an air filtration mask system. The mask assembly consists of a base made of a pliable but firm material, such as silicone or other comparable material, to form an air tight seal around the mouth and nose of a wearer, a filter holder, and an air filter. The base has ribbed studs in it which allow for a filter holder, also made of a firm but pliable material like silicone or other comparable material, to securely attach, forming an air tight seal, to the base by means of holes in the filter holder and filter holder latches located around the rim of the filter holder. A replaceable air filter can then attach to the filter holder by means of ribbed studs in the filter holder through holes along the rim of the air filter. The slope and shape of the air filter is designed to keep the velocity of air passing through the filter fabric low to allow for maximum efficiency of particle removal and decrease resistance to airflow through the air filter. An optional fashion mask cover can be attached to the front of the filter holder, making the mask more attractive and inviting to wear, while still allowing the filter holder to detach from the base, allowing a wearer access to the mouth and nose area without losing the tight seal between the base member and the face of the wearer. An optional fashion scarf or bandana can be attached to the mask assembly so that the mask can stay completely hidden while the mask is worn.

Accordingly, it is a primary objective of the instant invention to provide an air filtration mask that allows a wearer easy access to the nose and mouth without losing the critical seal between the mask and the face.

It is a further objective of the instant invention to provide an air filtration mask where the removable filter holding portion of the mask is attached by studs or a hinge, allowing the mask to open up, providing access to the nose and mouth while keeping the filter holding portion nearby.

It is yet another objective of the instant invention to provide an air filtration mask with a fashionable covering, making a person more likely to wear the air filtration mask.

It is further an objective of the instant invention to provide an air filtration mask where the base portion of the mask which makes contact with the face of a wearer is made of a firm but pliable material to create a tight seal with the face of a wearer while remaining comfortable for the wearer.

It is a still further objective of the instant invention to provide an air filtration mask that is easy to take on and off by having quick-attach adjustable straps that do not need to be stretched over the head.

It is an additional objective of the instant invention to provide an air filtration mask system where the base member and filter holder are reusable portions while the filter itself can be replaced when necessary.

It is yet another additional objective of the instant invention to provide replaceable filters that are sloped and shaped to decrease the velocity of air passing through the filter to improve filtering efficiency.

It is a further objective of the instant invention to provide a mask that conforms to the curvature of the face for the entirety of the mask, whereby the mask is made to conform to the face and hold its shape by use of face molding rings inserted in both the mask base and the filter holder.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 illustrates an individual wearing the air filtration mask with the fashion cover.

FIG. 2A is a pictorial view of the filtration mask with the base member and filter holder member shown connected.

FIG. 2B is a pictorial view of the base member, filter holder member, and fashion mask cover member when connected together to form the filtration mask assembly.

FIG. 2C is a bottom view of the air filtration mask illustrated in FIGS. 2A and 2B.

FIG. 2D is a cross sectional bottom view of one side of the air filtration mask.

FIG. 2E is a cross sectional bottom view of one side of the air filtration mask including the holder latch.

FIG. 2F is a cross sectional bottom view of one side of the air filtration mask having magnetic connectors.

FIG. 2G is a cross sectional bottom view of one side of the air filtration mask having magnetic connectors.

FIG. 2H illustrates the filtration mask with the base member and filter holder member shown using magnetic connection.

FIG. 2I bottom view of the embodiment of the air filtration mask using magnetic connection

FIG. 3A is a pictorial view of the base member and filter holder member interface.

FIG. 3B is a perspective view of the base member and filter holder member with filtration unit.

FIG. 3C illustrates the inner surface of the base member and the filter holder member without the filtration unit inserted therein.

FIG. 3D illustrates the base member and the filter holder member with magnetic connecting members embedded therein.

FIG. 4A is a side view of the filter member.

FIG. 4B is a side view of a filter member having a vent.

FIG. 4C is a front view of the filter member having a vent.

FIG. 5A is a side view of the assembled filtration mask.

FIG. 5B is a side view of the assembled filtration mask having magnetic connectors.

FIG. 6A is a side view of the filter holder member with a filter member connected thereto.

FIG. 6B is a side view of the filter holder member with a filter member connected thereto using magnetic connectors.

FIG. 7A is a side view of the fully assembled filtration mask.

FIG. 7B is a side view of the fully assembled filtration mask using magnetic connectors.

FIG. 8A is a side view depicting the attachment of the filter holder member to the base member.

FIG. 8B is a side view depicting the attachment of the filter holder member to the base member using magnetic connectors.

FIG. 9 is a side view of a complete mask with adjustable straps.

FIG. 10A shows an illustrative adjustment piece.

FIG. 10B is a side view of the adjustment piece shown in FIG. 10A.

FIG. 11A is an embodiment of a neck hanger.

FIG. 11B illustrates an embodiment of a quick latch connector.

FIG. 12 is a back view of an embodiment of the fashion cover member.

FIG. 13 is a front view of the fashion cover member, illustrating decorative indicia.

FIG. 14 is a front view of the fashion cover member, illustrating additional types of decorative indicia.

FIG. 15 illustrates a fashion cover connection pin.

FIG. 16 is a side view of the fashion cover connection pins.

FIG. 17 illustrates an embodiment of the fashion cover ring.

### DETAILED DESCRIPTION OF THE FIGURES

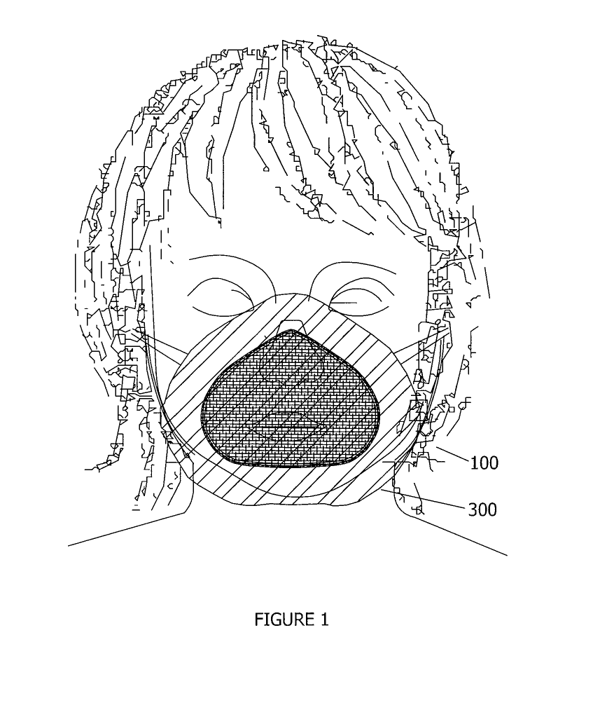

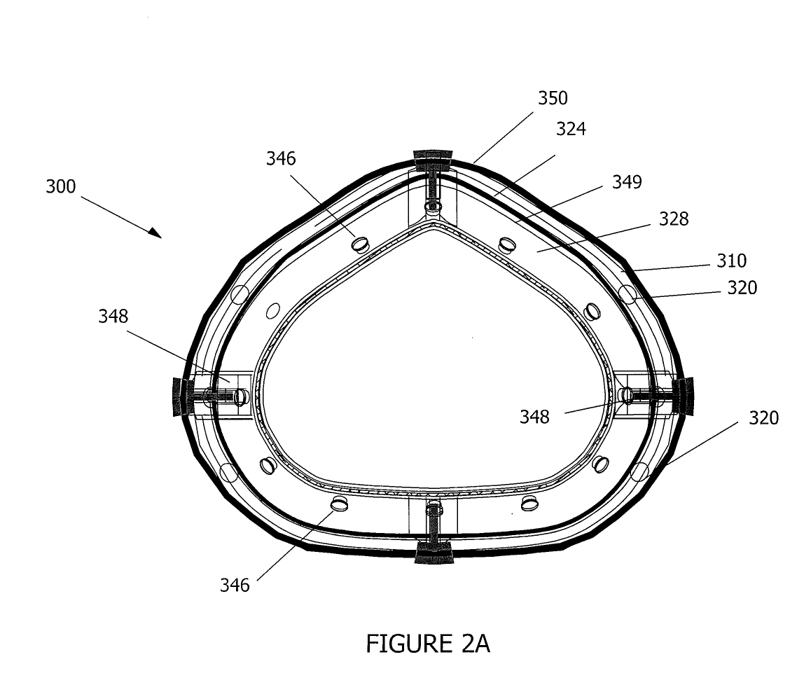

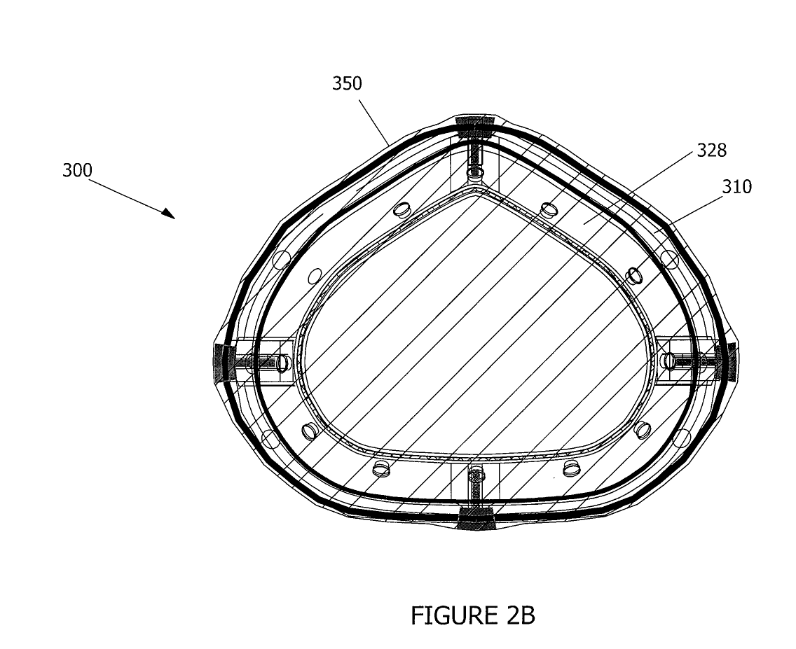

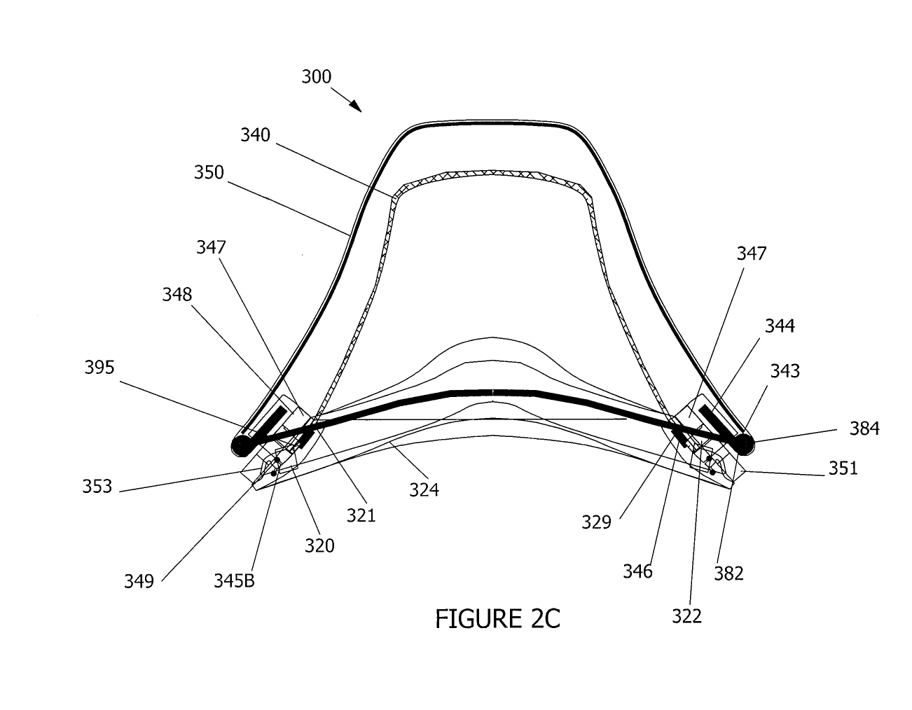

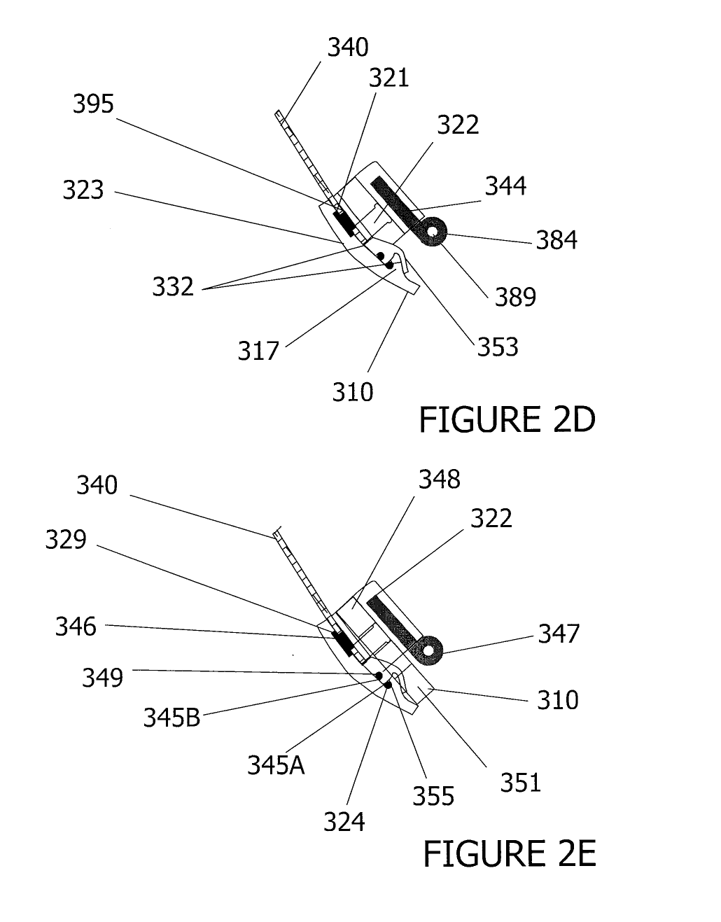

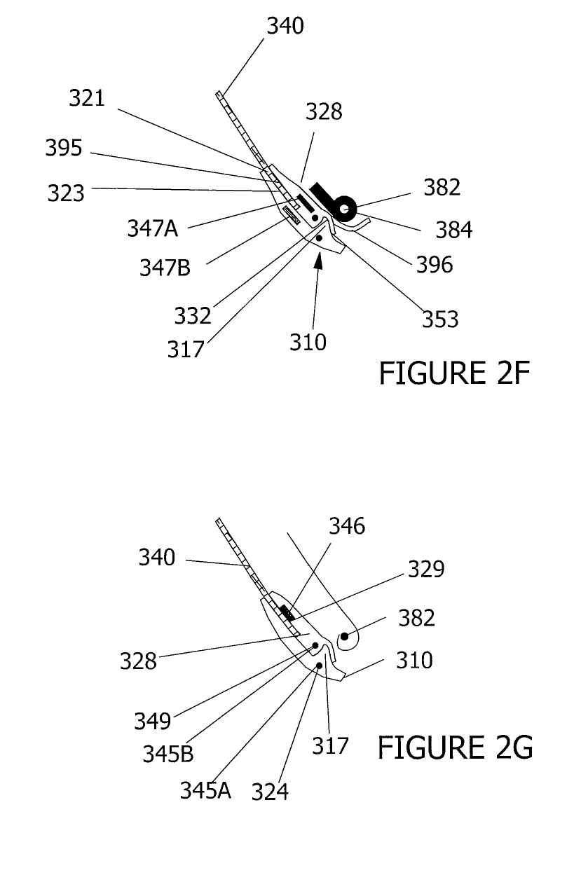

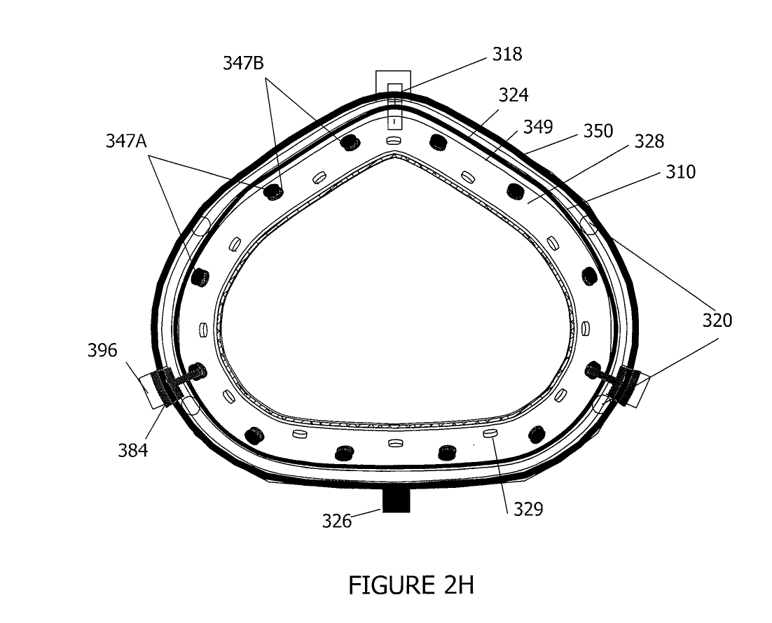

FIG. 1 illustrates a filtration mask or mask assembly, referred to generally as 300 which can be worn by an individual 100 to prevent exposure from harmful substances. Referring to FIGS. 2A and 2B, the air filtration mask 300 comprises individual connectable components secured together using a plurality of connecting members to form the working filtration mask or mask assembly 300. The filtration mask 300 comprises a base member 310, a filter holder member 328, and an optional fashion mask cover member 350. The filter holder member 328 is removably engaged with the base member 310 whereby the filter holder member 328 can be removed from the base member 310, while the base member 310 remains secured or attached to a user's face. In this manner, the filter holder member 328 can be removed without removing the seal formed between the base member 310 and the skin of the user's face. The fashion mask cover member 350 is construed and arranged to extend over and cover the base member 310 and the filtration holder member 328. Preferably, the base member 310 and the filter holder member 328 have corresponding shapes and/or are mirror images of each other so that, when secured together, they provide a shape defining the filtration mask or mask assembly 300. In addition, several connecting members, i.e. components that connect one component or member of the filtration mask 300 to the corresponding connecting members located on another member of the filtration mask 300 (such as for example the connection of the base member 310 and the filter holder member 328) are positioned within each member so that when one member, i.e. the base member 310 or the filer holder member 328, is connected to another or laid on top of each other, the corresponding connecting members are aligned together.

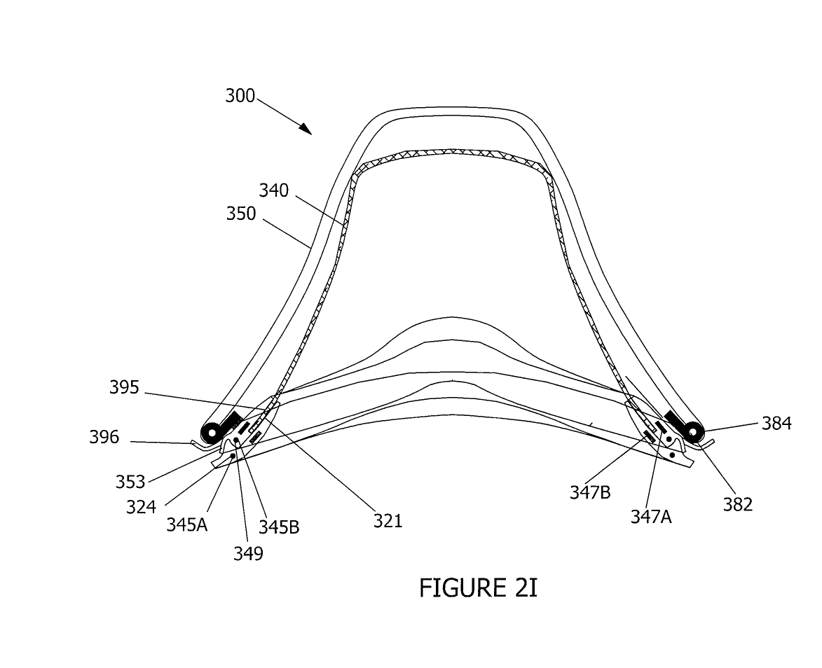

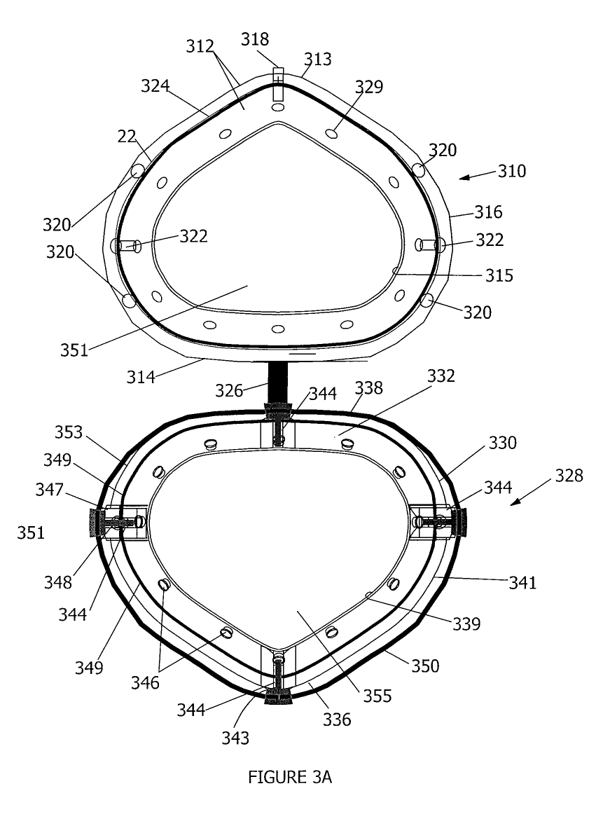

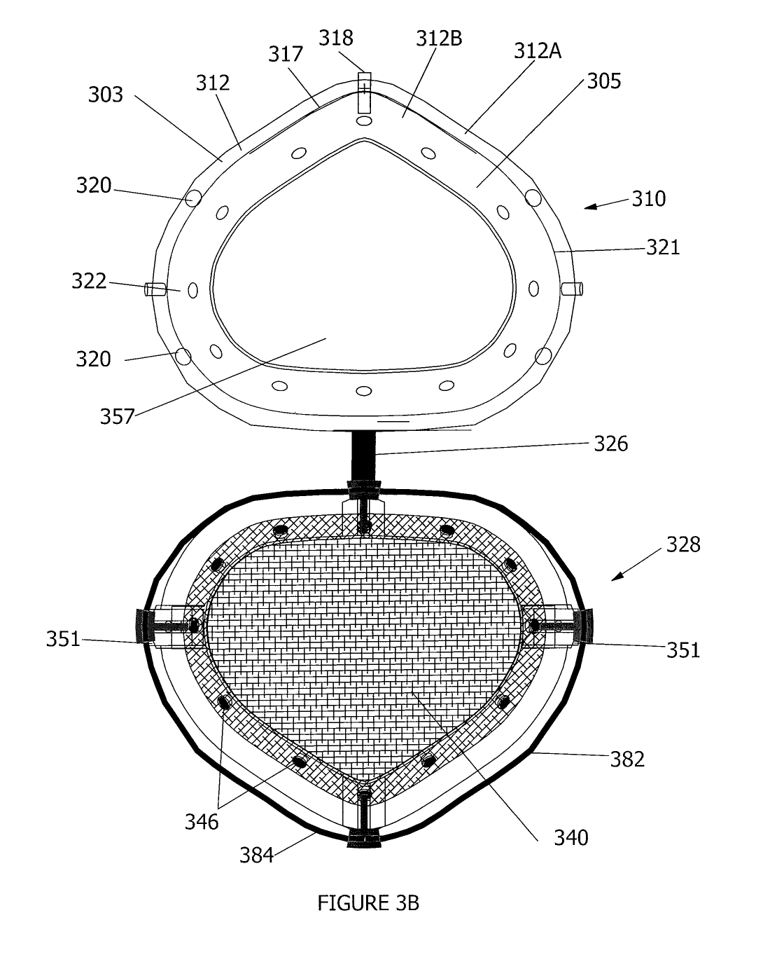

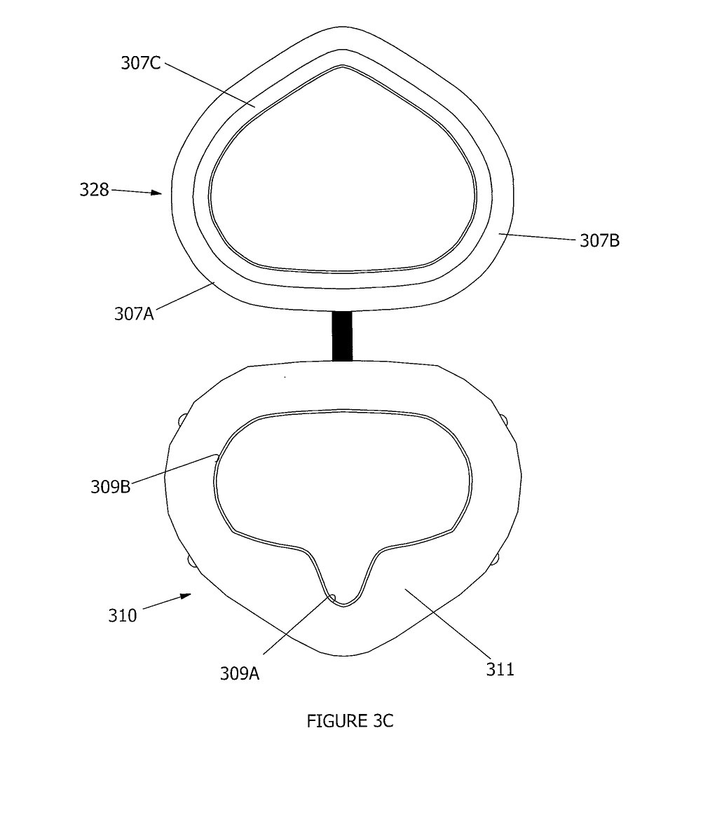

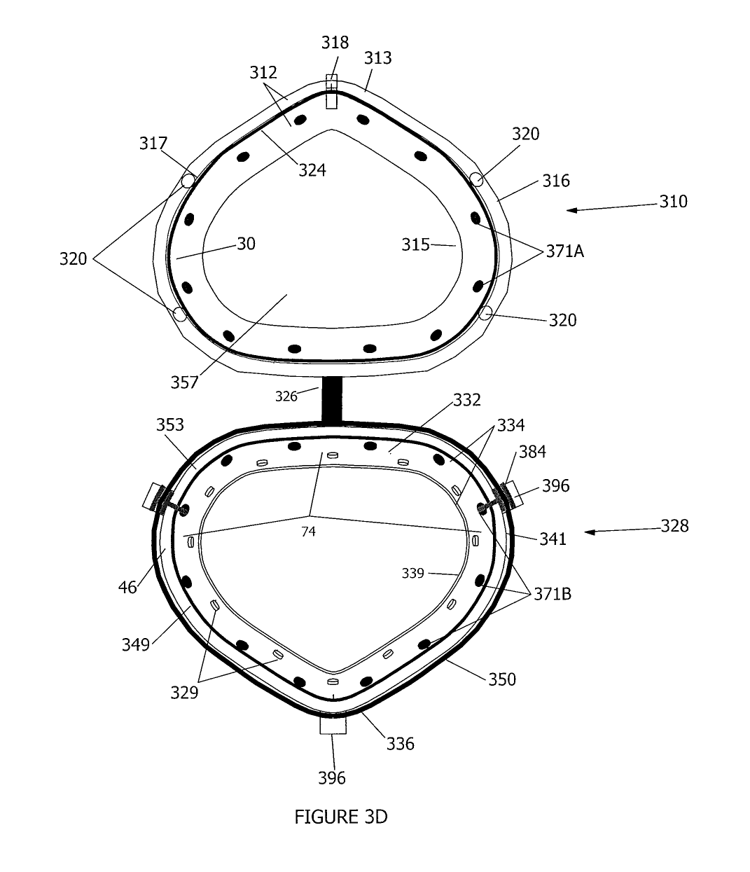

Referring to FIG. 3A-3C, the base member 310 is illustrated in a separated position from the filter holder member 328. The base member 310 is comprised of a base member main body, illustrated herein as a face gasket 312. Preferably, the face gasket 312 is made of a pliable, yet firm material such as silicone or similar material to create a tight seal with the face of a wearer. The face gasket 312 comprises a top end 313 (i.e. the end closest to the nose when placed on a user's face), and a bottom end 314 (i.e. the end furthest from the nose when placed on the user's face). The face gasket 312 further comprises a first side edge or proximal side edge 315 (i.e. the edge closest to the nose when placed on a user's face) and a second side edge or distal side edge 316 (i.e. the edge furthest from nose when placed on a user's face). The face gasket 312 may be constructed to have a first portion 312A sized and shaped to secure or be placed onto the surface of the skin of the user. FIG. 3B illustrates the outside surface of the mask base that connect to the filter when closed securing the elements in place. FIG. 3C illustrates the wearer's viewpoint or inside of the mask. The first portion 312A has a surface or wall 303 that rises away from the user's face, terminating in a support ridge 317. Rising from or below the support ridge 317 is a second portion 312B of the face gasket 312. The second portion 312B has a surface or wall 305 and forms a recessed holder seat 321. The wall 305 is preferably sized and shaped to have the same dimensions and/or curvature of portions of the filter holder member 328. In this manner, when the filtration mask 300 is in the assembled position, portions of the filter holder member 328 rests against the surface or wall 305 and be positioned within recessed holder seat 321 (defined as a gap formed between the filter holder member and base member 310 when together; such gap is filled by the filter member 340 when all three members are together). The support ridge 317 improves the seal between the base member 310 and the filter holder member 328. The recessed holder seat 321 insures a seal of the filter member 340 between the base member 310 and the filter holder member 328. As shown in FIG. 3C, the inner surface (secures to the face of the user) 311 of the face gasket 312 is flat and sized and shaped to fit the counter of the user's face. For example, face gasket 312 may be shaped to have a U-shaped or V-shaped portion 309A would fit the contour or outer surface area of a user's nose, and a generally oblong or a rectangular shape with rounded edges portion 309B to fit around the user's mouth. Also shown FIG. 3C is the filter holder member 328, without the filter member 340 inserted therein. The filter holder member 328 is preferably sized and shaped in a similar configuration as the base member 310. FIG. 3B further illustrates the filter holder member 328 having a first portion or wall 307A that ends in an edge 307B and a second portion or wall 307C that extends from 307B. Filter holder has a flap 353 that ends Such shape helps form a seal when the base member 310 and the filtration member 328 seals together by resting on the support ridge 317 of the base member 310.

Positioned throughout the base member main body are filtration mask connection members which are sized and shaped to receive or be inserted into corresponding filtration mask connection members on other components of the filter mask 300. A first base member main body connecting member, illustrated herein as a fashion scarf connection opening 318, may be positioned at or along the top end 313. Positioned at or near the distal side edge 316 is a plurality of a second set of base member main body connection members, illustrated herein as strap studs 320. The strap studs 320 are sized and shaped to receive and hold a strap connector. While the strap studs 320 are shown positioned at or near the distal side edge 316, such positioning is illustrative only and not intended to be limiting. A third set of base member main body connection members, illustrated herein as ribbed base studs 322 is placed along the face gasket 312 in between the proximal side edge 315 and the distal side edge 316, see for example FIG. 3A or 3B. For added support, the base member main body may contain a base member main body support ring 324, illustrated herein as a 16 GA HWG wire (1.34 mm) (see FIG. 2A, 2E, 2G or 3A). The base member main body support ring 324 may be made of moldable metal so the wearer can shape the rings to conform to and hold the curvature of the wearers face for the entirety of the mask. Connected to at least a portion of the bottom end 314 at one end and to at least a portion of the filter holder member 328 at a second end is a hinge connection 326, illustrated herein as an elongated, elastic member, designed to provide or maintain a connection or engagement between the base member 310 and the filter holder member 328 when not secured to each other in a manner as illustrated in FIG. 2A or FIG. 2B.

The filter holder member 328 is comprised of a filter member main body 330 having a filter holder member seal 332 and a recessed filter holder seal 334. The filter member main body 330 comprises a top end 336 (i.e. the end closest to the nose when placed on a user's face), and a bottom end 338 (i.e. the end furthest from the nose when placed on the user's face). The filter member main body 330 further comprises a first side edge or proximal side edge 339 (i.e. the edge closest to the nose when placed on a user's face) and a second side edge or distal side edge 341 (i.e. the edge furthest from the nose when placed on a user's face). Positioned throughout the filter holder member main body are filtration mask connection members which are sized and shaped to receive or be inserted into corresponding filtration mask connection members on other components of the filter mask 300. A first filter holder member main body connection member, illustrated herein as fashion cover connection opening(s) 343, is/are positioned at or along the top end 336 and along the distal side edge 341. A plurality of receiving areas, illustrated as a channel 344, is positioned between the proximal side edge 339 and the distal side edge 341. The channels 344 are sized and shaped to fit a corresponding connecting member on other components, such as a connecting member pin associated with the fashion mask cover member 350.

Positioned between the proximal side edge 339 and the distal side edge 341 of the of filter holder member main body are a plurality of a second set of filtration mask connection members or connectors, illustrated herein as filtration member studs 346. The filtration member studs 346 maybe countersunk into the filtration member stud insert or apertures 329 in the filter holder member 328 to help secure and seal the connection. A locking device, illustrated herein as a filter holder latch 347 is secured to the filter holder member 328 with filter holder latch straps 348 having latch holes for the ribbed base stud 322 to pass through, see also FIG. 2A. For added support, the filter holder member main body may include filter holder member main body support ring 349, illustrated herein as a 16 GA HWG wire (1.34 mm) (see FIG. 3A). The filter holder member main body support ring 349 may be made of moldable metal so the wearer can shape the rings to conform to and hold the curvature of the wearers face for the entirety of the mask. As shown in FIGS. 2D and 2E, the base member main body support ring 324 is held inside a base member main body support ring notch 345A in the base member 310. The filter holder member main body support ring 349 is held inside a filter holder member main body support ring notch 345B positioned in the filter holder member 328. The base member main body support ring 324 and the filter holder member main body support ring 349 work together to form and hold the seal between the filter holder member 328 and the mask base member 310. The filtration mask 300 may be constructed to use alternative connectors to connect the base member 310 and the filter holder 328.

Referring to FIG. 3D, a plurality of alternative securing devices, illustrated herein as filter holder magnets 371A are used. The filter holder magnets 371A are embedded in the filter holder member 328. An equal number of base member magnets 371B are embedded in the base member 310. When the filter holder magnets 371A and the base member magnets 371B are brought nearby the polarity snaps the two in place tightly holding the base member 310 to the filter holder member 328. Preferably, the magnets 371A and 371B may be any type of permanent magnet.

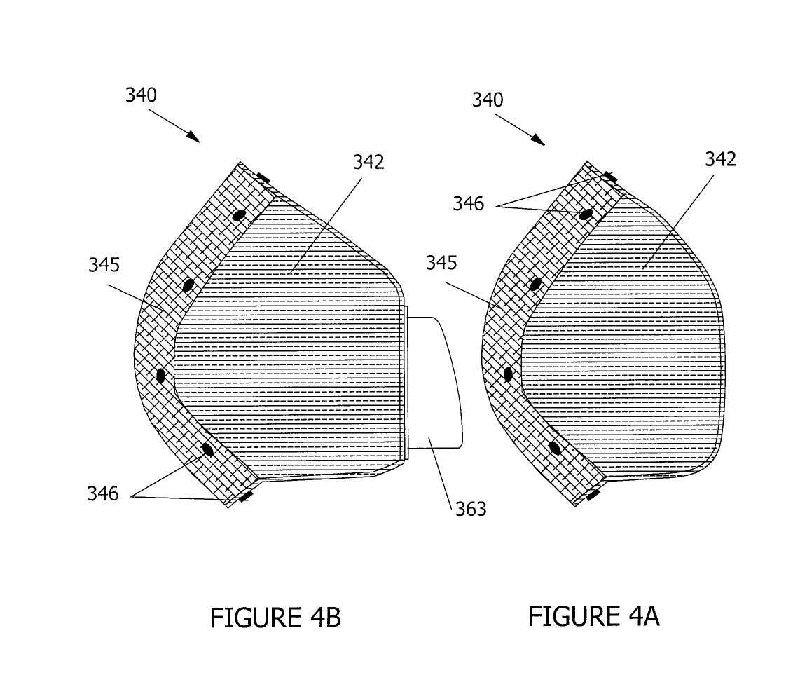

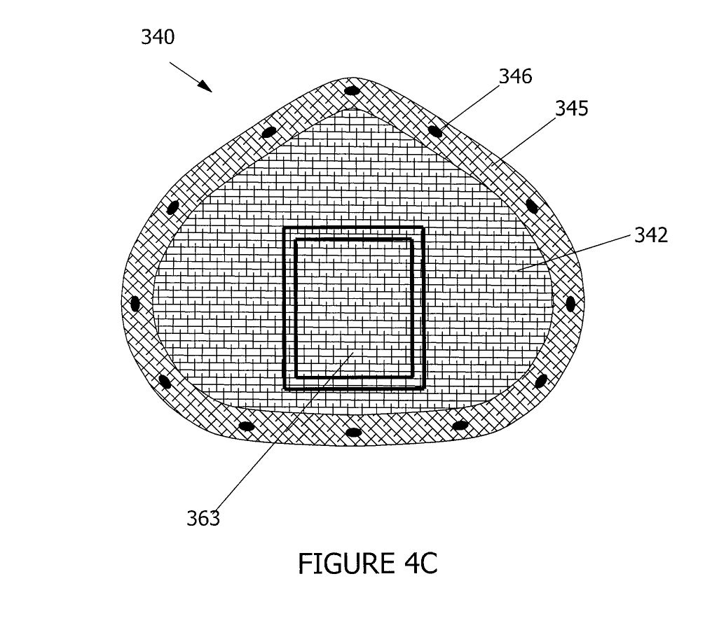

FIGS. 4A-4C illustrate a filter member 340 prior to attachment. The filter member 340 comprises a filter fabric 342 constructed and arranged to filter the flow of air passing through the filter member 340 when the filtration mask 300 is used by a wearer. Filter alignment connecting mechanisms, illustrated herein as connectoror filter stud 346 are spaced around the rim 345 of the filter member 340 so that it can connect to the filter holder member 328. Other connecting mechanisms, such as loop and hook fastener fastening material, such as VELCRO, can be used as well. The filter alignment holes 337 can be inserted attached to the filter studs 346 located inside the filter holder member 328 to secure the filter member 340. The filter member 340 may further contain a vent 363, see FIGS. 4B and 4C. The filter member 340 is inserted into the opening 355 (see FIG. 3A) of the filtration holder member 328, and eventually inserted into the opening 357 of the base member 310. Preferably, the filter fabric 342 is any material having at least 95% filter efficiency against solids and liquid particles, such as the material used in the 3M TEKK, N95 respirator.

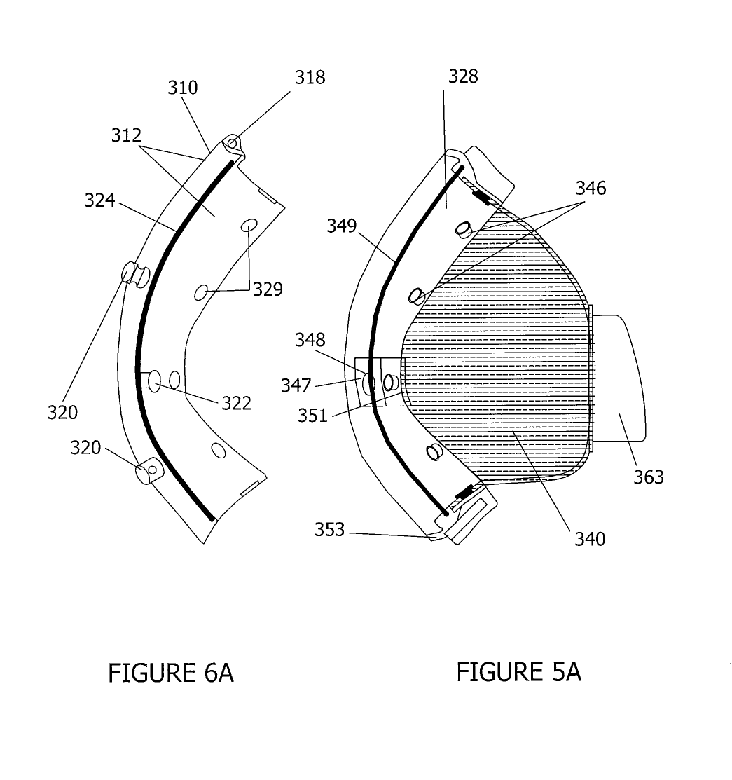

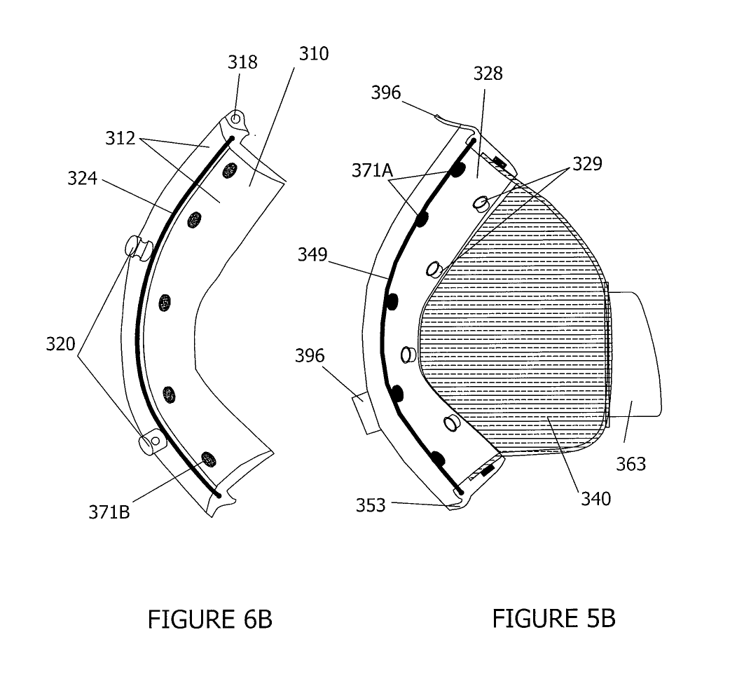

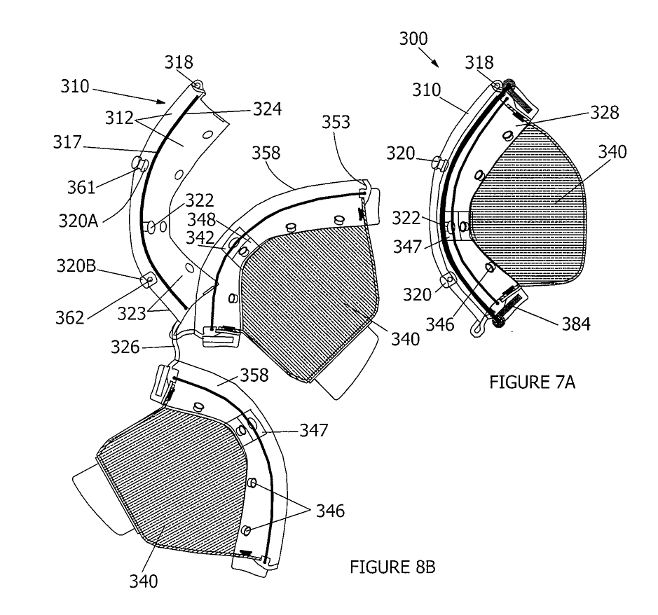

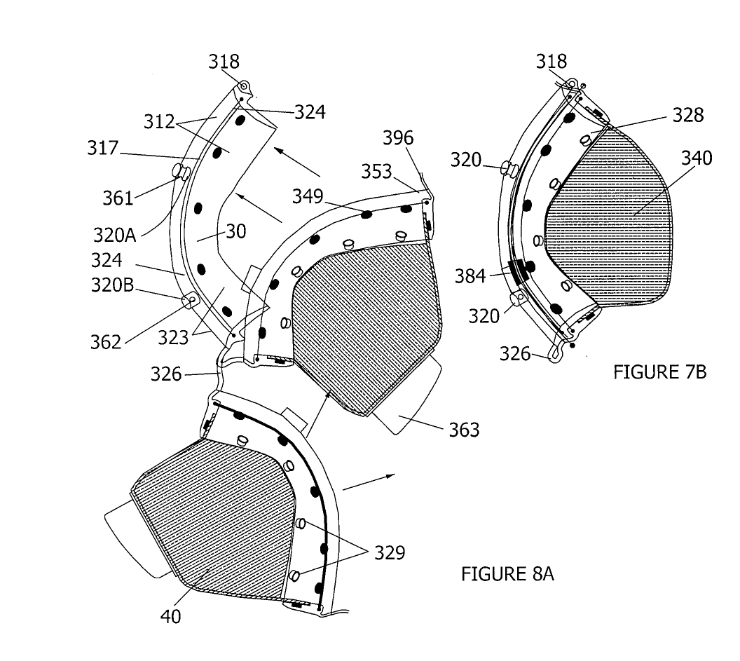

FIG. 5A or 5B is a side view of the filter holder member 328 with the filter member 340 inserted and secured therein. Referring to FIGS. 6A/6B, a side view of the base member 310 prior to insertion and securing of the filter holder member 328 with filter member 340 is shown. FIG. 7A or 7B illustrates a side view of the air filtration mask 300 having completed attachment of the filter member 340, filter holder member 328, and base member 310. The filter holder latches 347 or the filter holder magnets 371A are present to attach the filter holder member 328 to the base member 310. While illustrated in one orientation in the figures, the filter holder latches 347 need not be placed on the filter holder member 328. Alternatively, the filter holder member 328 can be placed on the base member 310. In the same manner, the filtration member studs 346 can be reversed so to be positioned on the filter holder member 328. The filter member 340 is connected to the filter holder member 328 by the filter alignment holes 337 (not shown) fixing the filter fabric 342 to the mask seat 323 (defined as the flat area on the base member 310 where the filter comes in contact with base member 310 forming a seal between the two). A filter seal flap 353 connected to the filter holder seal 332 helps connect the filter holder member 328 to the base member 310 along the mask member support ridge 317.

Referring to FIG. 8A or 8B, the attachment and removal of the filter holder member 328 with the filter member 340 to/from the base member 310 is shown. The filter holder member 328 with filter member 340 pivots towards the base member 310 around the hinge 326. The filter holder member 328, when not latched to the base member 310 by the connection of the filter holder latch 347 or the filter holder magnets 371A can hang from the base member 310 by the hinge 326. The hinge 326 may be made of continuous rubber or other similar material from the base member 310 to the filter holder member 328. Depressing a spring loaded filter member holder latch button 351 (see for examples, FIGS. 3B, 2E) opens the filter holder latch 347 so the ribbed base studs 322 connect through latch 348. Use of a spring loaded filter holder member latch button 351, however is not required. Once the ribbed base studs 322 are through the latch, the latch can be released, securing the base member 310 to the filter holder member 328 until the filter member holder latch button 351 is released. The filter holder latch 347, in contact with the ribbed base studs 322, brings the filter holder seal in contact with the support ridge 317, sealing the mask and filter. The face gasket 312 seals the filtration mask 300 to the wearer's face. The recessed holder seat 321 and the filter member studs 346 connect the filter holder member 328 to the filter member 340. When straps are connected to the base strap studs 320, the face gasket 312 can form a tight seal with the face of a user, and the filter fabric 342 will prevent the wearer from inhaling pollutants and pathogens. A completed attachment of the filter holder member 328 with filter member 340 and the base member 310 is shown from the side in FIG. 7A or 7B. When the filtration mask 300 is complete, the recessed holder seat 321 holds the filter member 340 interfacing with the mask seat 323, thus creating an air tight fit. Simultaneously, the base member main body support ring 324 and the filter holder member main body support ring 349 work together to form and hold the seal between the filter holder member 328 and the mask base member 310.

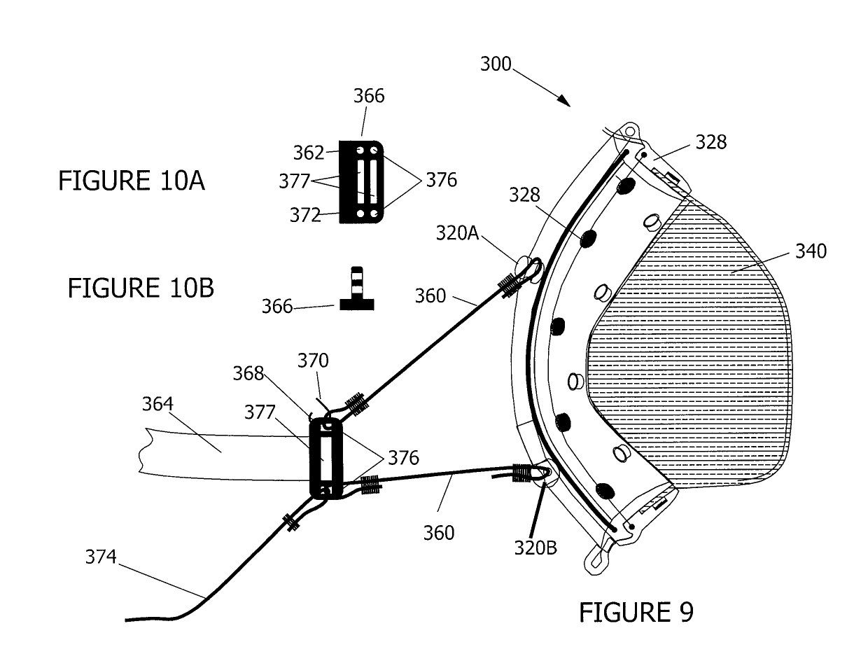

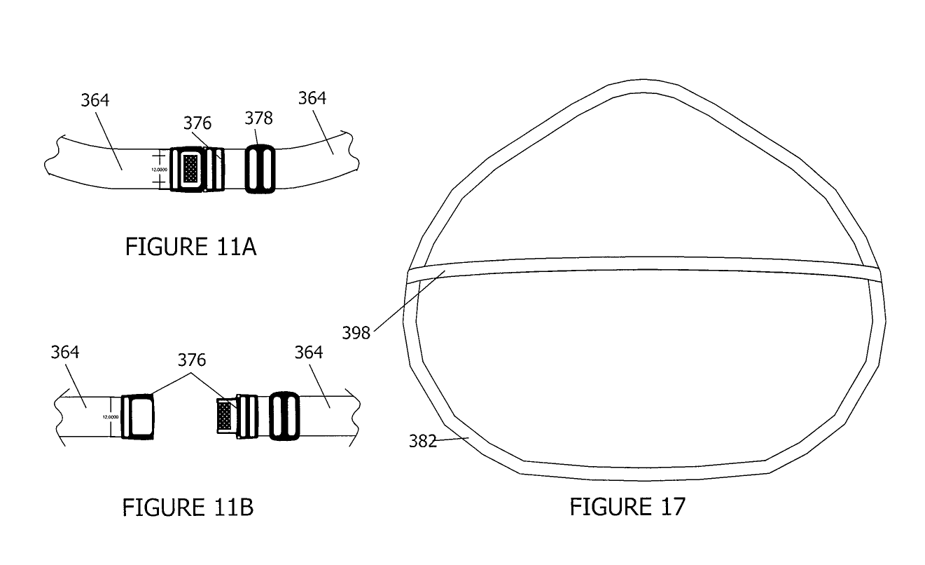

Referring to FIGS. 9-10B, the filtration mask is shown with connection cords 360. The connection cords 360 are shown passing through the base strap studs 320 to provide a mechanism to attach the filtration mask 300 to the face of a wearer. As shown in FIGS. 7A/7B or 8A/8B, the base strap studs 320 may be configured to allow for engagement with connection cords 360. For example, the base strap studs 320A may contain a hole or aperture portion 361 to allow a portion of the connection cord 360 to loop through. Alternatively, the base studs 320B may contain an opening 362, thereby allowing the connection cord 360 to be looped though the opening 362. Adjustable straps 364 attach on each side of the base member 310 and are connected together by a strap adjustment piece 366 and the connection cord 360. Each strap adjustment piece 366 contains an opening 368 to allow for a hook 370 to connect to a fashion scarf or bandana. The strap adjustment piece 366 may contain additional openings such as a neck hangar opening 372 to connect a neck hangar 374. The neck hangar 374, which can be an elongated or looped material or cord, is sized and shaped to hold the filtration mask 300 around the wearer's neck when the adjustable straps 364 are released. Each strap adjustment piece 366 also contains multiple (2 each) mask base connection cord openings or quick connect latches 376 for attachment of the connection cords 360 on the opposite end from the base strap studs 320 and strap slots 377 for the connection of the adjustable straps 364. FIGS. 11A and 11B show adjustable straps 364 with quick connect latches 376, making the mask easy to put on or remove. Use of the straps 364 with quick connect latches 376 also eliminates the need to bring straps over the head of the wearer. When the quick connect latches 376 are disconnected, the optional neck hanger 374 allows the mask to stay near the wearer. The length of the adjustable straps 364 may be adjusted by using adjustment clip 378.

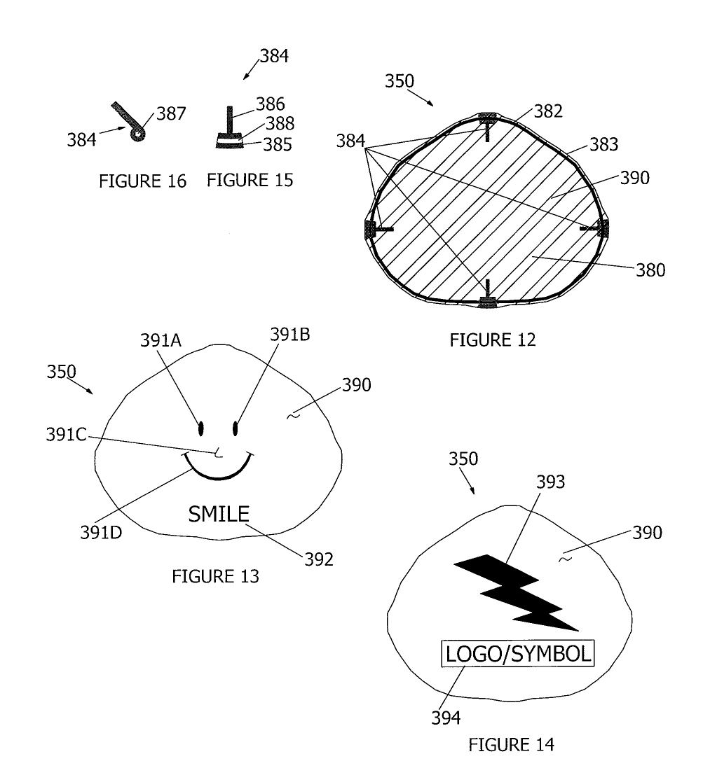

FIGS. 12-14 illustrate an embodiment of the fashion mask cover member 350. FIG. 30 shows the inner side 380 of the fashion mask cover 350. A moldable fashion mask cover support ring 382 is located around the rim or perimeter 383 of the fashion mask cover member 350. A plurality of filtration mask connection members, illustrated herein as fashion cover connection pins 384 are used to secure the fashion mask cover member 350 to the filter holder member 328. The fashion cover connection pins 384 contain a first portion 385 and a second elongated member 386 extending from the first portion 385, see FIG. 15. The second elongated member 386 may be magnetized. As such, the magnetized portion of the pin is attracted to the filter holder magnets 347A attaching the fashion cover to the rest of the filtration mask 300. If not magnetized, an opening 387 allows for the support ring 382 to be inserted therein and rest within a lumen 388, see FIGS. 15 and 16. While four fashion cover connection pins 384 are illustrated situated around the rim or perimeter 383, the fashion mask cover member 350 may utilize as little as one fashion cover connection pin 384, less than four, or more than four. The fashion cover connection pins 384 are constructed and arranged to slide into connection openings 343 positioned at or along the top end 336 and along the distal side edge 341 of the filtration member 358 and into the plurality of receiving area channel 344. If magnets 371A and 371B are used, the fashion cover connection pins 384 are constructed and arranged to snap onto the filter holder magnets 347A positioned at or along the top end 336 and along the distal side edge 341 of the filtration member 358. An elastic band sewn in the edge of the fashion mask cover member 350 can be used to connect the fashion mask cover member 350 to the moldable metal support ring 382. The moldable metal support ring 382 can be bent to adjust to the contours of the face and filtration mask 300.

In an alternative embodiment, FIG. 17 illustrates the moldable fashion mask cover support ring 382 is shown around the perimeter of the mask and spaced from the edge of the filter member 340. The moldable fashion mask cover support ring 382 may have a spacing member 398, illustrated as elongated member bar that connects from side to side. The elongated member may be formed integral with the mask or detachable.

The fashion mask cover member 350 is preferably a shaped material that covers other components of the filtration mask 300. The fashion mask cover member 350 may be made of any suitable breathable material, including but not limited to cloth (woven or knitted). The materials can be made from natural, synthetic, or cellulose fibers, such as material typically used in the fashion/clothing industry, including but not limited to cotton, wool, flax, silk, nylon, polyesters, and may be designed to provide visual appeal. The visual appeal may be provided through decorative components such as the use of indicia comprising prescribed patterns, words, symbols, logos, colors, shapes, numbers, emblems, images, or combinations thereof. FIGS. 13 and 14 illustrate the outer surface 390. As shown in FIG. 13, the decorative indicia may include an image of a face having eyes 391A, 391B, a nose 391C, and mouth 391D. The decorative indicia may include wording such as ‘SMILE” 392. FIG. 14 illustrates the decorative indicia shown as an image or symbol, illustrated as a lightning bolt 393 and a logo or other symbol 394. The logo or symbol could be for example, a logo from a sports team, or a company such as NIKE or APPLE. The logo 394 may be one color, represented by shading, and the rest of the outer surface 390 may not be colored or may include one or more different colors.

Referring back to FIG. 2C, the optional fashion mask cover member 350 covers the filtration mask 300 with the fashion mask cover support ring 382 extending over the filter member 340 down to the face of a wearer to cover the face gasket 312 of the filtration mask 300. The fashion mask cover member 350 attaches over fashion mask cover support ring 382 by slipping the fashion cover connection pins 384 into the fashion cover connection openings 343 and into the receiving area channel 344 or by clipping the fashion cover connection pins 384 onto filter holder magnets 371A. When the filtration mask 300 is complete, the recessed holder seat 321 holds the filter member 340 interfacing with the mask seat 323, creating an air tight fit. The strap studs 320 found around the outside of the base of the mask can be used to connect the connection cords 360.

FIGS. 2D and 2E show a cross section of a portion of the filtration mask 300, highlighting the connection between the base member 310, the filter holder member 328, and the filter member 340. The filter holder seal 332 helps the filter holder member 328 to maintain an air tight seal with the base member 310 when attached by folding over the support ridge 317. The ribbed base stud 322 can be seen attaching to a filter holder latch 347. Depressing the spring loaded filter member holder latch button 351 releases the filter holder latch 347 from the ribbed base stud 322 connected to the base member 310. This action releases the filter holder member from the base member 310. When closed, the filter holder latch 347 is secured around the ribbed base stud 322 by the spring loaded latch. The fashion cover connection pins 384 hold the fashion cover support ring 382 and is secured to the filter holder member 328 in the fashion cover connection openings 343 molded into the top of the filter holder latch strap 348. As illustrated in the figures, the filter holder member seal 332 is positioned to help seal the connection between the filter holder member 328 and the base member 310 by means of the filter seal flap 353 of the filter holder member 328 overlapping the support ridge 317 of the base member 310 when attached. The recessed holder seat 321 between the filter holder member seat 395 (the flat area on the filter holder member 328 where the filter comes in contact with the filter holder forming a seal) and the mask seat 323 provides a location for the filter member 340 to attach. The filter holder latches 347 attach to the filter holder member 328 by the filter holder straps 348 that project from the filter holder member 328 and wrap around the latches filter holder latches 347 holding them firmly in place.

FIGS. 2F, 2G, 2H, 2I, illustrate the filtration mask 300 using magnets 271A and 371B as connectors. Referring specifically to FIGS. 2F and 2G, the filter holder seal 332 helps the filter holder member 328 to maintain an air tight seal with the base member 310 when attached by folding over the support ridge 317. The filter holder magnets 371A and the base member magnets 371B can be seen snapped together. The polarity is strong enough to penetrate the thin silicone walls of the base member 310 and filter holder member 328 that the magnets are embedded within. Pulling on the filter holder 396 releases the magnets. This action releases the filter holder member 328 from the base member 310. The fashion cover connection pins 384 hold the fashion cover support ring 382 by the filter holder magnets 347A attracted to the magnetized pins. As illustrated in the figures, the filter holder member seal 332 is positioned to help seal the connection between the filter holder member 328 and the base member 310 by means of the filter seal flap 353 of the filter holder member 328 overlapping the support ridge 317 of the base member 310 when attached. The recessed filter holder seal 334 between the filter holder member seat 395 and the mask seat 323 provides a location for the filter member 340 to attach. The filter holder magnets 371A and the base member magnets 371B are embedded in the silicone rubber of the mask base member 310 and the filter holder member 328 holding them firmly in place.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. An air filtration mask comprising:
a base member with a top end and a bottom end, a proximal edge and a distal edge, constructed and arranged to fit over the nose and mouth of a user so that said top end covers the nose and said bottom end covers the mouth of said user, said base member having a plurality of base member connecting elements positioned between said proximal edge and said distal edge of said base member and constructed and arranged to engage at least a portion of a filter holder member;
a filter holder member with a top end, a bottom end, a proximal edge, and a distal edge, said filter holder member having a plurality of filter holder member connecting elements constructed and arranged to engage at least a portion of a base member; and
a filter member having a proximal side and a distal side, said filter member constructed and arranged to engage with said filter holder.

2. The air filtration mask according to claim 1 wherein said base member is made of a pliable material.

3. The air filtration mask according to claim 1 wherein said plurality of base member connecting elements are ribbed base studs.

4. The air filtration mask according to claim 1 wherein said filter holder member and said base member contain magnets for creating an air tight seal between said base member and said filter holder.

5. The air filtration mask according to claim 1 wherein said air filter is constructed and arranged of a filter fabric having at least a 95% filter efficiency against solids and liquids.

6. The air filtration mask according to claim 1 wherein said filter member further comprises at least one hole in said proximal side, said hole constructed and arranged to couple with said filter holder.

7. The air filtration mask according to claim 1 wherein said filter member further comprises a vent.

8. The air filtration mask according to claim 1 further including a fashion mask cover member.

9. The air filtration mask according to claim 1 wherein said fashion mask cover member is configured to secure to said filter holder member.

10. The air filtration mask according to claim 1 wherein said fashion mask cover member comprises a fabric material having decorative indicia.

11. The air filtration mask according to claim 10 wherein said decorative indicia comprises a prescribed pattern, word, symbol, colors, shape, number, emblem, logo, image, or combinations thereof.

12. The air filtration mask according to claim 1 wherein said filter member is slidably and removably engaged with said filter holder member.

13. The air filtration mask according to claim 1 wherein said base member is hingedly connected to said filter member, whereby said filter member can be removed from engagement from said base member when said base member remains secured to a user's face.

14. The air filtration mask according to claim 1 wherein said base member and said filter holder have the same shape.

15. The air filtration mask according to claim 1 wherein said base member and said filter holder are mirror images.
